(19) United States
(12) Patent Application Publication
(10) Pub. No.: US 2025/0296319 A1
(43) Pub. Date: Sep. 25, 2025

(54) LIQUID DISCHARGE HEAD, LIQUID DISCHARGE APPARATUS, LIQUID DISCHARGE METHOD, AND STORAGE MEDIUM

(71) Applicants: Katsuhiro TOBITA, Ibaraki (JP); Takahiro YOSHIDA, Kanagawa (JP)

(72) Inventors: Katsuhiro TOBITA, Ibaraki (JP); Takahiro YOSHIDA, Kanagawa (JP)

(21) Appl. No.: 19/069,274

(22) Filed: Mar. 4, 2025

(30) Foreign Application Priority Data
Mar. 22, 2024 (JP) 2024-045933

(51) Int. Cl. B41J 2/045; B41J 2/155; B41J 2/21

(52) U.S. Cl. CPC B41J 2/04541; B41J 2/04581; B41J 2/155; B41J 2/2103

(57) ABSTRACT

A liquid discharge head includes multiple heads and circuitry. The multiple heads discharge liquid droplets. The multiple heads include at least a first head and a second head. The first head has first nozzle arrays each having first nozzles. The second head is disposed upstream from the first head. The second head has second nozzle arrays each having second nozzles. The second nozzle arrays have second overlapping region overlapped with first overlapping region of the first nozzle arrays. The circuitry causes the first head not to discharge the liquid droplets from the first nozzles of one or more of the first nozzle arrays from an upstream end of the first head in the first overlapping region and causes the second head not to discharge the liquid droplets from the second nozzles of one or more of the second nozzle arrays from a downstream end in the second overlapping region.

### CROSS-REFERENCE TO RELATED APPLICATION

This patent application is based on and claims priority pursuant to 35 U.S.C. § 119(a) to Japanese Patent Application No. 2024-045933, filed on Mar. 22, 2024, in the Japan Patent Office, the entire disclosure of which is hereby incorporated by reference herein.

### BACKGROUND

### Technical Field

The present disclosure relates to a liquid discharge head, a liquid discharge apparatus, a liquid discharge method, and a storage medium storing a plurality of instructions.

### Related Art

Currently, a liquid discharge apparatus increases a conveyance speed of a discharge target to achieve high productivity and uses a wide medium (print medium) as the discharge target.

### SUMMARY

The present disclosure described herein provides an improved liquid discharge head including multiple heads and circuitry. The multiple heads discharge liquid droplets onto a medium conveyed relative to the multiple heads in a conveyance direction. The multiple heads include at least a first head and a second head. The first head has first nozzle arrays each having first nozzles arrayed in an array direction intersecting the conveyance direction. The first nozzle arrays are arrayed in the conveyance direction and have first overlapping region in one end of the first head in the array direction. The second head is disposed upstream from and adjacent to the first head in the conveyance direction. The second head has second nozzle arrays each having second nozzles arrayed in the array direction. The second nozzle arrays are arrayed in the conveyance direction and have second overlapping region, overlapped with the first overlapping region in the array direction, in another end of the second head in the array direction. The circuitry causes the first head not to discharge the liquid droplets from the first nozzles of one or more of the first nozzle arrays from an upstream end of the first head in the conveyance direction in the first overlapping region as a first non-discharge nozzle array, causes the first head to discharge the liquid droplets onto the medium from the first nozzles other than the first non-discharge nozzle array in the first overlapping region, causes the second head not to discharge the liquid droplets from the second nozzles of one or more of the second nozzle arrays from a downstream end in the conveyance direction in the second overlapping region as a second non-discharge nozzle array, and causes the second head to discharge the liquid droplets onto the medium from the second nozzles other than the second non-discharge nozzle array in the second overlapping region.

Further, the present disclosure described herein provides an improved liquid discharge method and a non-transitory storage medium storing a plurality of instructions which, when executed by one or more processors, causes the one or more processors to perform a method. The liquid discharge method (method) includes discharging liquid droplets onto a medium and conveying at least one of multiple heads or the medium relative to another in a conveyance direction. The multiple heads include at least a first head and a second head. The first head has first nozzle arrays each having first nozzles arrayed in an array direction intersecting the conveyance direction. The first nozzle arrays are arrayed in the conveyance direction and have first overlapping region in one end of the first head in the array direction. The second head is disposed upstream from and adjacent to the first head in the conveyance direction. The second head has second nozzle arrays each having second nozzles arrayed in the array direction. The second nozzle arrays are arrayed in the conveyance direction and have second overlapping region, overlapped with the first overlapping region in the array direction, in another end of the second head in the array direction. The liquid discharge method (method) further includes causing the first head not to discharge the liquid droplets from the first nozzles of one or more of the first nozzle arrays from an upstream end of the first head in the conveyance direction in the first overlapping region as a first non-discharge nozzle array, causing the first head to discharge the liquid droplets onto the medium from the first nozzles other than the first non-discharge nozzle array in the first overlapping region, causing the second head not to discharge the liquid droplets from the second nozzles of one or more of the second nozzle arrays from a downstream end in the conveyance direction in the second overlapping region as a second non-discharge nozzle array, and causing the second head to discharge the liquid droplets onto the medium from the second nozzles other than the second non-discharge nozzle array in the second overlapping region.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a printer according to a first embodiment of the present disclosure;

FIG. 2 is a plan view of a head unit of the printer of FIG. 1;

FIG. 3 is a plan view of multiple heads adjacent to each other;

FIG. 4 is a block diagram illustrating a system configuration of a printer;

FIG. 5 is a front view of transverse faces of heads in a nozzle overlapping region;

FIG. 6 is a functional block diagram illustrating control for discharging liquid droplets from nozzles by a print controller;

FIG. 7 is a diagram illustrating a dot-data generation mask and landed dots in the vicinity of a nozzle overlapping region;

FIG. 8 is another diagram illustrating a dot-data generation mask and landed dots in the vicinity of a nozzle overlapping region;

FIG. 9 is still another diagram illustrating a dot-data generation mask and landed dots in the vicinity of a nozzle overlapping region; and

FIG. 10 is a schematic diagram of an electrode manufacturing apparatus according to a second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of a liquid discharge head, a liquid discharge apparatus, a liquid discharge method, and a storage medium are described in detail below with reference to the accompanying drawings.

### First Embodiment

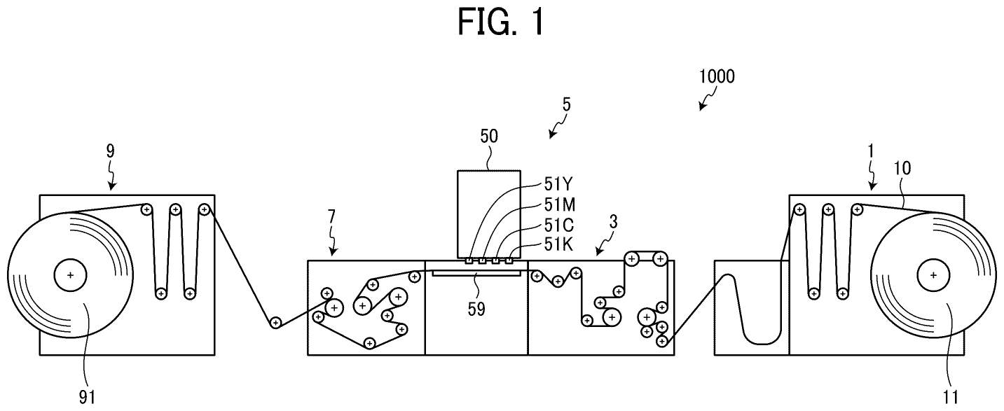

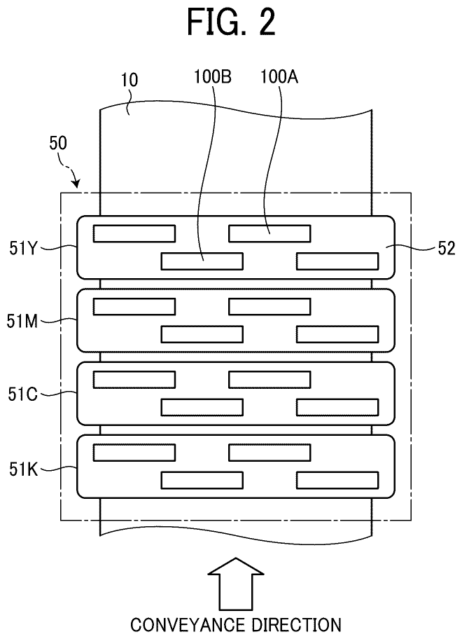

FIG. 1 is a schematic diagram illustrating a configuration of a printer 1000. FIG. 2 is a plan view of a head unit 50 of the printer 1000. The printer 1000 illustrated in FIG. 1 is a line type inkjet recording apparatus including the line head unit 50.

The printer 1000 as a liquid discharge apparatus includes a loading device 1, a guide conveyor 3, a printing device 5, a drying device 7, and an ejection device 9. The loading device 1 loads a medium 10. The guide conveyor 3 as a conveyor guides and conveys the medium 10 from the loading device 1 to the printing device 5. The printing device 5 includes the head unit 50 and performs printing to form an image on the medium 10 by discharging liquid onto the medium 10. The drying device 7 dries the medium 10. The ejection device 9 collects the medium 10 ejected from the drying device 7.

The medium 10 is fed from a winding roller 11 of the loading device 1, guided and conveyed with rollers of the loading device 1, the guide conveyor 3, the drying device 7, and the ejection device 9, and wound around a take-up roller 91 of the ejection device 9. For example, the medium 10 is conveyed at a high speed of about 100 m/min in the printer 1000.

In the printing device 5, the medium 10 is conveyed on a conveyance guide 59 so as to face the head unit 50. When the medium 10 is conveyed on the conveyance guide 59, the head unit 50 discharges liquid onto the medium 10 to form an image on the medium 10.

The head unit 50 includes, for example, full-line head arrays 51K, 51C, 51M, and 51Y for four colors from the upstream side in a conveyance direction of the medium 10. The full-line head arrays 51K, 51C, 51M, and 51Y may be referred to simply as the “head array 51” when colors are not distinguished.

Each of the head arrays 51 is a liquid discharge device (may be referred to as a liquid discharge head) to discharge liquid (e.g., ink) of black (K), cyan (C), magenta (M), or yellow (Y) onto the medium 10 conveyed in the conveyance direction. The number and types of colors are not limited to the above-described four colors of K, C, M, and Y and may be any other suitable number and types.

In each head array 51, for example, as illustrated in FIG. 2, multiple heads including heads 100A and 100B are disposed in a staggered arrangement on a base 52 to form the head array 51. The head array 51 is not limited to such an arrangement. The heads 100A and 100B may be referred to simply as a head 100 in the following description. The head 100A is a downstream head (i.e., a first head) in the conveyance direction, and the head 100B is an upstream head (i.e., a second head) upstream from the head 100A in the conveyance direction. Thus, multiple heads 100 are arranged adjacent to each other to print on a wide medium. The configuration of the head array 51 is not limited to the above-described configuration.

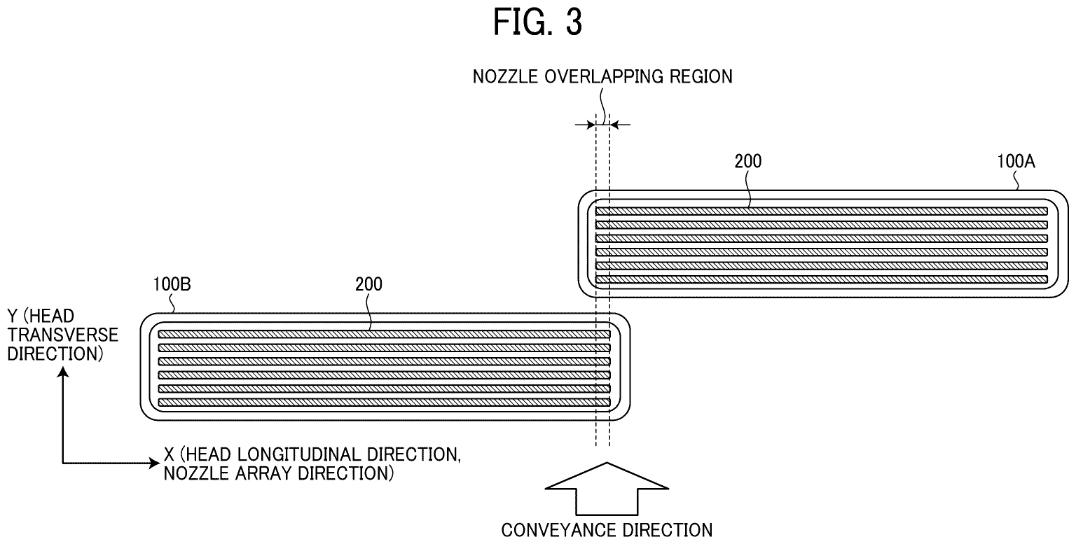

FIG. 3 is a plan view of multiple heads (e.g., the head 100A and the head 100B) adjacent to each other. Each of the head 100A and the head 100B is a line type head having multiple nozzles (discharge nozzles) arrayed in multiple rows to discharge liquid. In FIG. 3, the number of rows of nozzle arrays included in each head 100 is six, but the number of rows of nozzle arrays is not limited to six. As illustrated in FIG. 3, each of the head 100A and the head 100B includes multiple nozzle arrays 200 arranged side by side in the transverse direction of the head 100 (Y direction). In each of the multiple nozzle arrays 200, multiple nozzles are arrayed in the longitudinal direction of the head 100, i.e., an array direction of the multiple nozzles (X direction). The head 100A has overlapped nozzles in one end of the multiple nozzles in the array direction (i.e., a first overlapping region), and the head 100B has overlapped nozzles in the other end of the multiple nozzles in the array direction (i.e., a first overlapping region). The overlapped nozzles (i.e., the first overlapping region) of the head 100A are overlapped with the overlapped nozzles (i.e., the second overlapping region) of the head 100B in a nozzle overlapping region in the array direction of the multiple nozzles (X direction). A conveyance airflow is generated in the same direction as the conveyance direction of the medium 10 directly below the multiple nozzles. The conveyance airflow becomes faster in proportion to the conveyance speed of the medium 10. The “conveyance direction” is a direction in which the medium 10 is moved (conveyed) relative to the head 100.

In the present embodiment, the line type inkjet recording apparatus as the printer 1000 is described, but an embodiment of the present disclosure is not limited thereto. An embodiment of the present disclosure can be similarly applied to a serial type (shuttle type) inkjet recording apparatus in which a carriage is moved (scanned). In both the line type and the serial type, a head on the downstream side (downstream in the conveyance direction of the medium) in the relative movement direction of the medium 10 with respect to the head 100 is referred to as the head 100A, and a head on the upstream side (upstream in the conveyance direction of the medium) is referred to as the head 100B. In other words, the phrase “the medium is conveyed relative to the head 100 in the conveyance direction” includes a case in which the head 100 is moved (conveyed) relative to the medium 10 not in motion. In this case, the “upstream” and “downstream” are determined based on the relative movement direction of the medium 10.

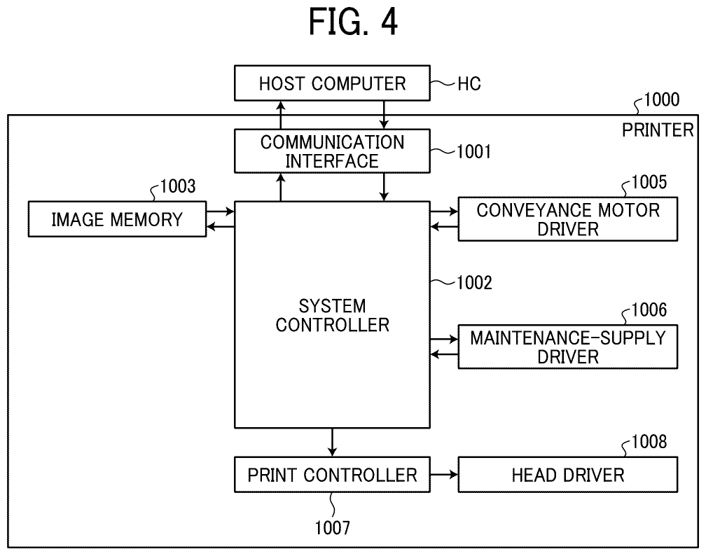

A system configuration of the printer 1000 will be described below. FIG. 4 is a block diagram illustrating a system configuration of the printer 1000. As illustrated in FIG. 4, the printer 1000 includes a communication interface 1001, a system controller 1002, an image memory 1003, a conveyance motor driver 1005, a maintenance-supply driver 1006, a print controller 1007, and a head driver 1008. The head driver 1008 may be mounted on each head array 51 or each head 100.

The communication interface 1001 is an interface unit that receives image data transmitted from a host computer HC. The image data transmitted from the host computer HC is taken into the printer 1000 via the communication interface 1001, and is temporarily stored in the image memory 1003.

The image memory 1003 is a storage unit that temporarily stores the image data input via the communication interface 1001. Data is read from and written to the image memory 1003 via the system controller 1002.

The system controller 1002 as a system circuitry includes a central processing unit (CPU) and peripheral circuits thereof. The system controller 1002 functions as a control device that controls the entire printer 1000 in accordance with a predetermined program, and also functions as an arithmetic device that performs various arithmetic operations. In other words, the system controller 1002 controls the respective units such as the communication interface 1001, the image memory 1003, the conveyance motor driver 1005, and the maintenance-supply driver 1006. The system controller 1002 also controls the print controller 1007 to drive the head 100 to discharge liquid.

The image memory 1003 stores programs executed by the CPU of the system controller 1002 and various data for control. The image memory 1003 is used as a temporary storage area for image data, and is also used as a program development area and a calculation work area for the CPU.

The conveyance motor driver 1005 is a driver to drive motors, for example, in the loading device 1, the guide conveyor 3, and the ejection device 9 in accordance with instructions from the system controller 1002.

The maintenance-supply driver 1006 is a driver to drive a supply-system block that controls the driving of liquid feed pumps and solenoid valves for the heads 100A and 100n, and a maintenance-system block that controls the driving of suction pumps and solenoid valves connected to caps for the heads 100A and 100B, in accordance with instructions from the system controller 1002.

The print controller 1007 has a signal processing function of performing, for example, various processes and corrections for generating a print control signal from the image data in the image memory 1003 in accordance with instructions from the system controller 1002. The print controller 1007 is a controller that supplies the generated print data (dot data) to the head driver 1008. The print controller 1007 controls a discharge amount and a discharge timing of liquid droplets discharged from the heads 100A and 100B via the head driver 1008 based on image data on which a desired signal processing is performed. Thus, an image is formed with a desired dot size and dot arrangement of the liquid droplets.

The head driver 1008 includes a drive circuit as circuitry that generates drive signals to be applied to piezoelectric elements of the heads 100A and 100B based on the image data transmitted from the print controller 1007 and applies the drive signals to the piezoelectric elements to drive the piezoelectric elements.

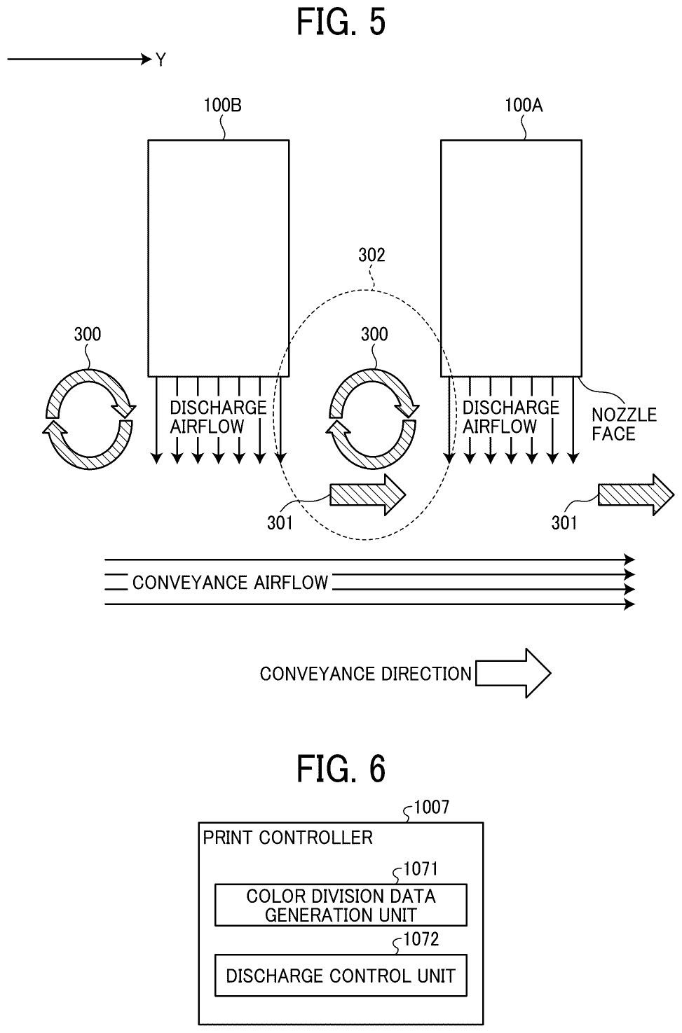

An airflow generated in the vicinity of the heads 100A and 100B adjacent to each other will be described below. FIG. 5 is a front view of transverse faces of the heads 100A and 100B in the nozzle overlapping region. The medium 10 is conveyed directly below nozzle face of each of the heads 100A and 100B at a high speed. As a result, the conveyance airflow flows directly below the nozzle face on which the nozzles are arrayed. Accordingly, on the upstream side of the heads 100A and 100B in the conveyance direction, the conveyance airflow and a discharge airflow caused by the liquid droplets discharged from the nozzles interfere with each other, and thus a vortex interference airflow 300 is generated. Further, a horizontal interference airflow 301 is generated on the downstream side of the heads 100A and 100B in the conveyance direction.

As a result, in a region 302 between the heads 100A and 100B adjacent to each other, the vortex interference airflow 300 and the horizontal interference airflow 301 interfere with each other, and thus a mutual interference airflow is generated. Due to such an influence, the landing positions of the liquid droplets discharged onto the medium 10 are deviated from desired positions, and thus white streaks or black streaks may occur in an image in the nozzle overlapping region. The white streaks or the black streaks are conspicuous when the gap between the nozzle face and the medium 10 is large (e.g., 2 mm or more). The mutual interference airflow becomes more pronounced when the speed and the air volume of the discharge airflow are increased, and further when the medium 10 is conveyed at high speed.

The position where the mutual interference airflow is generated is affected by various factors such as the size of the discharged liquid droplets, the distance between the heads, and the shape of the nozzle face. Accordingly, a strong mutual interference airflow may be generated near the head 100A, and vice versa, or both the heads 100A and 100B may be evenly affected by the mutual interference airflow.

In the present embodiment, as described later, the influence of the mutual interference airflow is reduced by controlling the nozzles to selectively discharge liquid droplets.

FIG. 6 is a functional block diagram illustrating control for discharging liquid droplets from the nozzles by the print controller 1007. The print controller 1007 includes a color division data generation unit 1071 and a discharge control unit 1072. Roughly speaking, the discharge control unit 1072 controls discharge of liquid (liquid droplets).

When the color division data generation unit 1071 receives image data to be printed, the color division data generation unit 211 generates color division data for each color of liquid used in the printer 1000 from the received image data. For example, when the printer 1000 uses liquids of C, M, Y, and K, the color division data generation unit 1071 generates color division data for each color of C, M, Y, and K from the received image data.

The discharge control unit 1072 applies a dot-data generation mask to the color division data of each color generated by the color division data generation unit 1071 to generate printed-dot data. The dot-data generation mask is, for example, a mask pattern for forming an image with printed dots mixed by the two adjacent heads 100A and 100B in the nozzle overlapping region (may be referred to simply as an overlapping region) of the ends of the adjacent heads 100A and 100B. The discharge control unit 1072 is a controller that controls the discharge of liquid droplets from the nozzles.

The liquid applied onto the medium 10 is fixed to the medium 10 to form dots in an image. More specifically, one liquid droplet formed by the liquid discharged from the head 100A or 100B lands on the medium 10, and then is dried and fixed to the medium 10. Thus, one dot in the image is formed on the medium 10. The image is formed as an aggregate of multiple dots.

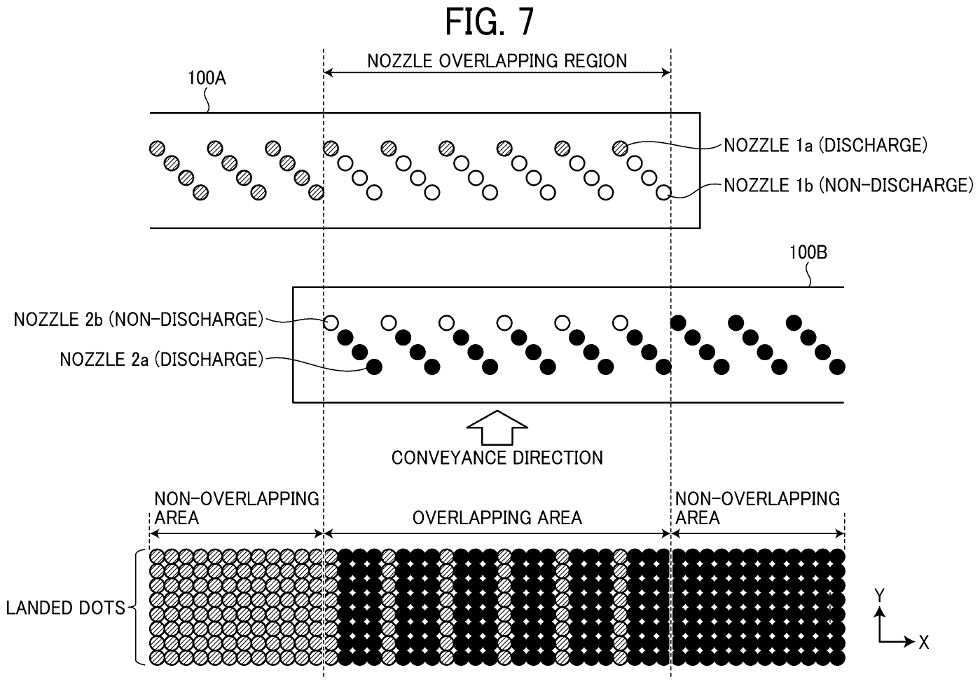

FIG. 7 is a diagram illustrating a dot-data generation mask and landed dots in the vicinity of the nozzle overlapping region. Although FIG. 7 illustrates the nozzle overlapping region formed by the right end of the head 100A and the left end of the head 100B, the same applies to the nozzle overlapping region formed by the left end of the head 100A and the right end of the head 100B as illustrated in FIG. 3. Although the number of nozzles in the nozzle overlapping region is 24 in each of the heads 100A and 100B in FIG. 7, the number of nozzles in the nozzle overlapping region may be more or less than 24.

The landed dots illustrated in FIG. 7 indicate dots formed of liquid droplets that are discharged from the head 100A and the head 100B and land at ideal positions on the medium 10. In FIG. 7, a non-overlapping area of the landed dots on the left side is formed by the liquid droplets discharged from the nozzles of the head 100A, and the non-overlapping area on the right side is formed by the liquid droplets discharged from the nozzles of the head 100B. An overlapping area of the landed dots, which are discharged from the nozzles in the nozzle overlapping region and land on the medium 10, is formed by the liquid droplets discharged from the nozzles of the heads 100A and 100n.

FIG. 7 illustrates the overlapping area of the landed dots formed by the liquid droplets discharged from nozzles 1a of the head 100A and the liquid droplets discharged from nozzles 2a of the head 100B. In FIG. 7, the nozzles 1a indicated by circles painted in a diagonal pattern and the nozzles 2a indicated by black circles are discharge nozzles from which the liquid droplets are discharged, and nozzles 1b and nozzles 2b indicated by white circles are non-discharge nozzles from which the liquid droplets are not discharged. In this example, since the upstream side of the head 100A in the conveyance direction (upstream in the conveyance direction of the medium 10) is greatly affected by the mutual interference airflow, the nozzles 1b in three nozzle arrays (i.e., upstream nozzle arrays) from the end of the head 100A (i.e., the downstream head) on the upstream side in the conveyance direction of the medium 10 are set as the non-discharge nozzles. The nozzles 2b in one nozzle array (i.e., a downstream nozzle array) from the end of the head 100B (i.e., the upstream head) on the downstream side in the conveyance direction of the medium 10 are set as the non-discharge nozzles. When the downstream side of the head 100B is greatly affected by the mutual interference air flow, the number of rows of nozzle arrays of the non-discharge nozzles from the end of the head 100B on the downstream side may be increased.

In the above-described example, in the nozzle overlapping region between the multiple heads which are disposed adjacent to each other, liquid droplets are not discharged from the nozzles in one or more nozzle arrays from the end of each of the respective heads facing each other. The number of rows of nozzle arrays from which the liquid droplets are not discharged (i.e., a number of rows of non-discharge nozzle arrays A) of the head 100A is different from the number of rows of nozzle arrays from which the liquid droplets are not discharged (i.e., a number of rows of non-discharge nozzle arrays B) of the head 100B. In other words, the number of rows of non-discharge nozzle arrays A and the number of rows of non-discharge nozzle arrays B satisfy a relationship of the following Expression 1 or Expression 2.

the number of rows of non-discharge nozzle arrays A>the number of rows of non-discharge nozzle arrays B Expression 1

the number of rows of non-discharge nozzle arrays A<the number of rows of non-discharge nozzle arrays B Expression 2

Such a dot-data generation mask allows the heads 100A and 100B to form an image with nozzle arrays that are affected by the airflow not used as the non-discharge nozzles in the nozzle overlapping region. Accordingly, the positional deviation of the landing positions due to the influence of mutual interferences of airflows generated between adjacent heads (the heads 100A and 100B) is reduced. As a result, the deterioration of image quality due to density unevenness, white streaks, or black streaks can be prevented. In other words, even when the mutual interference airflow is generated at a position closer to either one of the heads 100A and 100B than to the other, for example, due to the head arrangement, the shape of the nozzle face of the head, and the size and the type of the liquid droplets, the influence of the mutual interference airflow can be avoided. As a result, the deterioration of image quality in the nozzle overlapping region can be prevented.

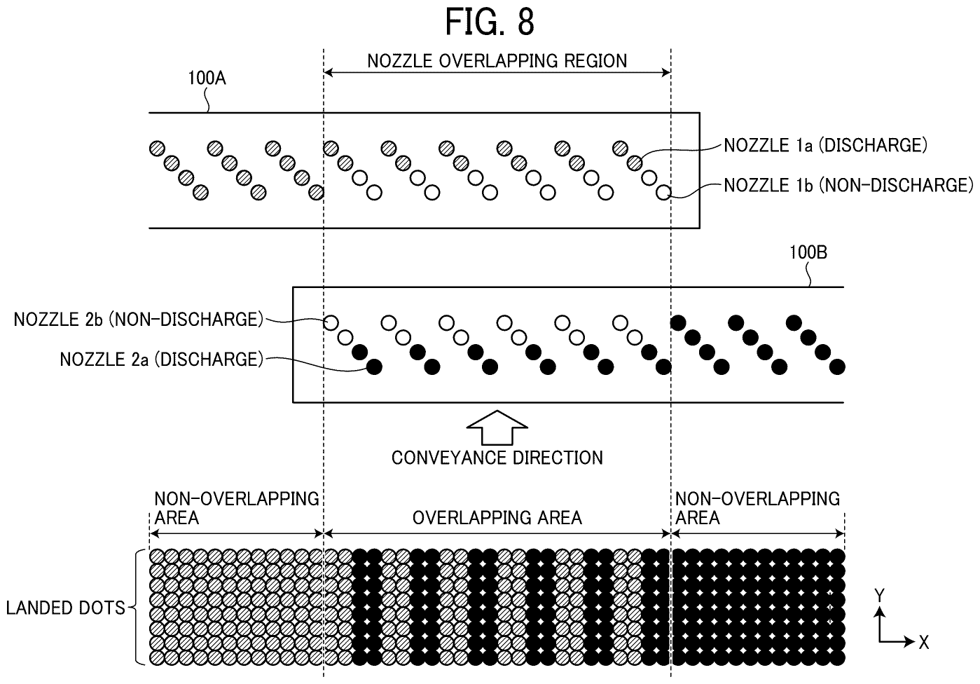

FIG. 8 is another diagram illustrating a dot-data generation mask and landed dots in the vicinity of the nozzle overlapping region. Similarly to FIG. 7, the overlapping area of the landed dots is formed of the liquid droplets discharged from nozzles of the head 100A and the head 100B in the nozzle overlapping region.

FIG. 8 illustrates the overlapping area of the landed dots formed by the liquid droplets discharged from the nozzles 1a of the head 100A and the liquid droplets discharged from the nozzles 2a of the head 100B. In FIG. 8, the number of the liquid droplets discharged from the nozzles 1a of the head 100A is the same as the number of the liquid droplets discharged from the nozzles 2a of the head 100B in the overlapping area. In this example, the number of discharge nozzle arrays of the head 100B is the same as that of the head 100A. In other words, the number of rows of non-discharge nozzle arrays A and the number of rows of non-discharge nozzle arrays B satisfy a relationship of the following Expression 3. In addition, when the total number of rows of nozzle arrays included in each of the heads 100A and 100B is an even number, half the number of rows of nozzle arrays of each of the heads 100A and 100B is the number of rows of non-discharge nozzle arrays.

the number of rows of non-discharge nozzle arrays A=the number of rows of non-discharge nozzle arrays B Expression 3

Such a dot-data generation mask allows the heads 100A and 100B to alternately discharge the same number of liquid droplets in the X direction to form the overlapping area of the landed dots. Accordingly, the numbers of the landed dots from the head 100A and the head 100B are even in the nozzle overlapping region, and thus the influence of variations in discharge characteristics between the heads 100A and 100B is not conspicuous.

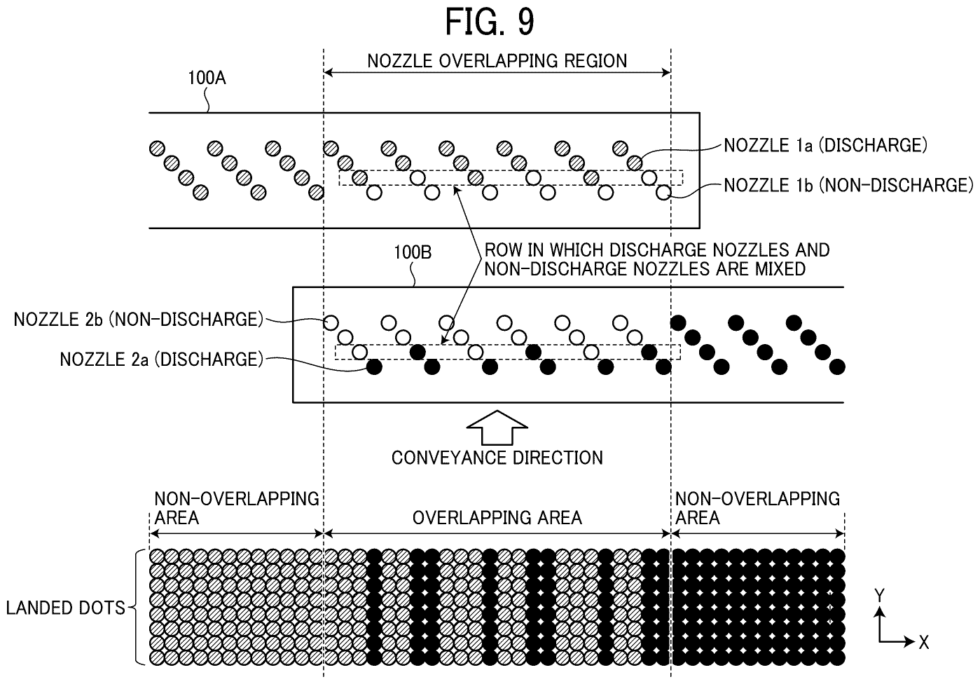

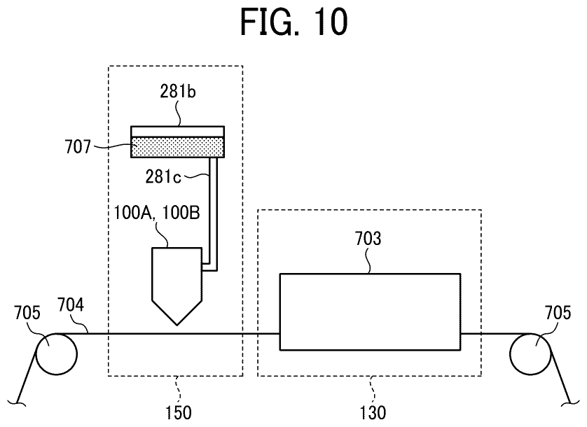

FIG. 9 is still another diagram illustrating a dot-data generation mask and landed dots in the vicinity of the nozzle overlapping region. Similarly to FIG. 7, the overlapping area of the landed dots is formed of the liquid droplets discharged from nozzles of the head 100A and the head 100B. In addition, each of the heads 100A and 100B has one or more nozzle array in which the discharge nozzles and the non-discharge nozzles are mixed.

In this example, each of the heads 100A and 100B has one or more nozzle arrays of the non-discharge nozzles 1b or 2b from the end of each of the heads 100A and 100B facing each other in the nozzle overlapping region, and further has one or more nozzle arrays (i.e., mixed nozzle arrays) in which the discharge nozzles 1a or 2a and the non-discharge nozzles 1b or 2b are mixed.

In each of the mixed nozzle arrays, the discharge nozzles and the non-discharge nozzles can be appropriately selected according to the factor of the generation of the mutual interference airflow. For example, in the mixed nozzle array surrounded by the broken line frame in FIG. 9, one nozzle from the end in the array direction is the non-discharge nozzle, but two or more nozzles from the end in the array direction may be the non-discharge nozzles.

Such a dot-data generation mask can select the non-discharge nozzles in the nozzle overlapping region in consideration of the vortex airflow when the strength of the vortex airflow varies in the X direction, or when a strong vortex airflow is generated in the vicinity of a specific position (for example, the end of the head). With such a configuration, the influence of a complicated vortex airflow generated by the mutual interference airflow can be avoided. As a result, the deterioration of image quality due to the white streaks or the black streaks in the nozzle overlapping region can be prevented.

As described above, according to one aspect of the present disclosure, the deterioration of image quality caused by mutual interference between airflows generated between adjacent heads in the nozzle overlapping region can be prevented.

### Second Embodiment

A description is given below of a second embodiment of the present disclosure. In the following description of the second embodiment, descriptions of elements identical or similar to those in the first embodiment are omitted, and differences from the first embodiment are described.

### Electrode Manufacturing Apparatus

The liquid discharge apparatus according to an embodiment of the present disclosure may also include an apparatus for manufacturing an electrode and an electrochemical element that is also referred to as an electrode manufacturing apparatus. The electrode manufacturing apparatus is described below.

FIG. 10 is a schematic diagram of an electrode manufacturing apparatus according to a second embodiment of the present disclosure. The electrode manufacturing apparatus is an apparatus for manufacturing an electrode including a layer containing an electrode material by discharging a liquid composition using a head module including the heads 100A and 100B described in the first embodiment.

### Device for Forming Layer Containing Electrode Material and Process of Forming Layer Containing Electrode Material

A discharge device in the electrode manufacturing apparatus illustrated in FIG. 10 is the head module. The liquid discharge head (head) of the head module discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus that forms an electrode composite layer containing an active material on an electrode substrate, i.e., a current collector, is described below. As illustrated in FIG. 10, the electrode manufacturing apparatus includes a discharge process device 150 and a heating process device 130. The discharge process device 150 performs a discharge process of applying a liquid composition onto a print base material 704 having a discharge target to form a liquid composition layer. The heating process device 130 performs a heating process of heating the liquid composition layer to obtain an electrode composite layer.

The electrode manufacturing apparatus includes a conveyor 705 that conveys the print base material 704. The conveyor 705 conveys the print base material 704 to the discharge process device 150 and the heating process device 130 in this order at a preset speed. A method of producing the print base material 704 having the discharge target such as an active material layer is not limited to any particular method, and a known method can be appropriately selected. The discharge process device 150 includes the heads 100A and 100B that perform an application process of applying the liquid composition onto the print base material 704, a storage container 281b that stores a liquid composition 707, and a supply tube 281c that supplies the liquid composition 707 stored in the storage container 281b to the heads 100A and 100B.

The discharge process device 150 discharges the liquid composition 707 from the heads 100A and 100B so that the liquid composition 707 is applied onto the print base material 704 to form a liquid composition layer in a thin film shape. The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130. Accordingly, the solvent is removed from the liquid composition layer. Thus, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

Programs executed in the printer 1000 as a liquid discharge apparatus are preinstalled in the image memory 1003 such as a read-only memory (ROM).

Alternatively, the programs executed in the printer 1000 as a liquid discharge apparatus may be stored, in an installable or executable file format, in a computer readable storage medium, such as a compact disc-read-only memory (CD-ROM), a flexible disk (FD), a compact disc-recordable (CD-R), and a digital versatile disc (DVD).

Various programs executed by the printer 1000 may be stored in a computer connected to a network such as the Internet and provided by being downloaded via the network. The program executed on the printer 1000 may be provided or distributed via a network such as the Internet.

The program executed on the printer 1000 has a modular configuration including the above-described units (the color division data generation unit 1071 and the discharge control unit 1072). The CPU (i.e., a processor) serving as actual hardware reads the program from the storage medium described above and executes the program so as to load these units described above on a main storage device to implement the color division data generation unit 1071 and the discharge control unit 1072 on the main storage device.

Each of the functions (the color division data generation unit 1071 and the discharge control unit 1072) described above can be implemented by one or more processing circuits. The term “processing circuit or circuitry” in the present specification includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit components arranged to perform the recited functions.

In the present disclosure, the term “liquid discharge apparatus” includes a liquid discharge head or a liquid discharge device (unit) and drives the liquid discharge head to discharge liquid. The term “liquid discharge apparatus” used herein includes, in addition to apparatuses to discharge liquid to a medium onto which liquid can adhere, apparatuses to discharge the liquid into gas (air) or a different liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

Further, the term “liquid” is not limited to a particular liquid and includes any liquid having a viscosity or a surface tension that can be discharged from the head. However, preferably, the viscosity of the liquid is not greater than 30 millipascal-second (mPa·s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The term “liquid discharge apparatus” may be an apparatus in which the liquid discharge head and the medium onto which liquid can adhere move relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The embodiments described above are presented as examples and are not intended to limit the scope of the present disclosure. The above-described embodiments can be implemented in other various forms, and various omissions, replacements, and changes can be made without departing from the scope of the present disclosure. In addition, the embodiments and modifications or variations thereof are included in the scope and the gist of the present disclosure, and also included in the scope of the appended claims and the equivalent thereof.

Aspects of the present disclosure are, for example, as follows.

### Aspect 1

A liquid discharge head includes multiple heads each having a nozzle array including multiple nozzles arrayed to selectively discharge liquid droplets from the nozzles onto a medium, and a controller to control the discharge of the liquid droplets from the nozzles. The liquid discharge head has a nozzle overlap region of the multiple heads at ends of the multiple heads, which are disposed adjacent to each other, in an array direction of the nozzle array. In the nozzle overlapping region, the controller sets nozzles in a first number of rows of the nozzle array, which is one or more rows, from an upstream end of a head on a downstream side among the adjacent multiple heads in a relative movement direction of the medium with respect to the liquid discharge head as non-discharge nozzles that do not discharge the liquid droplets, and sets nozzles in a second number of rows of the nozzle array, which is one or more rows, from a downstream end of a head on an upstream side among the adjacent multiple heads in the relative movement direction as the non-discharge nozzles.

In other words, a liquid discharge head includes multiple heads and circuitry. The multiple heads discharge liquid droplets onto a medium conveyed relative to the multiple heads in a conveyance direction. The multiple heads include at least a first head and a second head. The first head has first nozzle arrays each having first nozzles arrayed in an array direction intersecting the conveyance direction. The first nozzle arrays are arrayed in the conveyance direction and have first overlapping region in one end of the first head in the array direction. The second head is disposed upstream from and adjacent to the first head in the conveyance direction. The second head has second nozzle arrays each having second nozzles arrayed in the array direction. The second nozzle arrays are arrayed in the conveyance direction and have second overlapping region, overlapped with the first overlapping region in the array direction, in another end of the second head in the array direction. The circuitry causes the first head not to discharge the liquid droplets from the first nozzles of one or more of the first nozzle arrays from an upstream end of the first head in the conveyance direction in the first overlapping region as a first non-discharge nozzle array, causes the first head to discharge the liquid droplets onto the medium from the first nozzles other than the first non-discharge nozzle array in the first overlapping region, causes the second head not to discharge the liquid droplets from the second nozzles of one or more of the second nozzle arrays from a downstream end in the conveyance direction in the second overlapping region as a second non-discharge nozzle array, and causes the second head to discharge the liquid droplets onto the medium from the second nozzles other than the second non-discharge nozzle array in the second overlapping region.

### Aspect 2

In the liquid discharge head according to Aspect 1, the second number of rows is different from the first number of rows.

In other words, a number of rows of the second non-discharge nozzle array is different from a number of rows of the first non-discharge nozzle array in the conveyance direction.

### Aspect 3

In the liquid discharge head according to Aspect 1, the second number of rows is larger than the first number of rows.

In other words, a number of rows of the second non-discharge nozzle array is larger than a number of rows of the first non-discharge nozzle array in the conveyance direction.

### Aspect 4

In the liquid discharge head according to Aspect 1, the second number of rows is smaller than the first number of rows.

In other words, a number of rows of the second non-discharge nozzle array is smaller than a number of rows of the first non-discharge nozzle array in the conveyance direction.

### Aspect 5

In the liquid discharge head according to Aspect 1, the second number of rows is the same as the first number of rows.

In other words, a number of rows of the second non-discharge nozzle array is equal to a number of rows of the first non-discharge nozzle array in the conveyance direction.

### Aspect 6

In the liquid discharge head according to any one of Aspects 1 to 5, the adjacent multiple heads have one or more nozzle arrays in which the non-discharge nozzles and discharge nozzles that discharge the liquid droplets are mixed in the nozzle overlapping region.

In other words, the circuitry causes the first head, in the first overlapping region to discharge the liquid droplets from the first nozzles in a part of a first mixed nozzle array in the first nozzle arrays and not to discharge the liquid droplets from the first nozzles in another part of the first mixed nozzle array in the first nozzle arrays, and causes the second head, in the second overlapping region to discharge the liquid droplets from the second nozzles in a part of a second mixed nozzle array in the second nozzle arrays and not to discharge the liquid droplets from the second nozzles in another part of the second mixed nozzle array in the second nozzle arrays.

### Aspect 7

In the liquid discharge head according to Aspect 6, the nozzle array in which the non-discharge nozzles and the discharge nozzles are mixed has one or more nozzles from an end in the array direction as the non-discharge nozzles.

In other words, the circuitry causes the first head not to discharge the liquid droplets from one or more of first nozzles from an end of the first mixed nozzle array in the array direction and the second head not to discharge the liquid droplets from one or more of the second nozzles from an end of the second mixed nozzle array in the array direction.

### Aspect 8

A liquid discharge apparatus includes the liquid discharge head according to any one of Aspects 1 to 7 and a system controller to drive the liquid discharge head to discharge a liquid.

In other words, a liquid discharge apparatus includes the liquid discharge head according to any one of Aspects 1 to 7, a conveyor to convey at least one of the liquid discharge head or the medium relative to another, and system circuitry to drive the liquid discharge head and the conveyor to selectively discharge the liquid droplets onto the medium to form an image on the medium.

### Aspect 9

A liquid discharge method is used in a liquid discharge head including multiple heads each having a nozzle array including multiple nozzles arrayed to selectively discharge liquid droplets from the nozzles onto a medium. The liquid discharge head has a nozzle overlap region of the multiple heads at ends of the multiple heads, which are disposed adjacent to each other, in an array direction of the nozzle array. The liquid discharge method includes a control step to control the discharge of the liquid droplets from the nozzles. In the nozzle overlapping region, the control step sets nozzles in a first number of rows of the nozzle array, which is one or more rows, from an upstream end of a head on a downstream side among the adjacent multiple heads in a relative movement direction of the medium with respect to the liquid discharge head as non-discharge nozzles that do not discharge the liquid droplets, and sets nozzles in a second number of rows of the nozzle array, which is one or more rows, from a downstream end of a head on an upstream side among the adjacent multiple heads in the relative movement direction as the non-discharge nozzles.

In other words, a liquid discharge method includes discharging liquid droplets onto a medium and conveying at least one of multiple heads or the medium relative to another in a conveyance direction. The multiple heads include at least a first head and a second head. The first head has first nozzle arrays each having first nozzles arrayed in an array direction intersecting the conveyance direction. The first nozzle arrays are arrayed in the conveyance direction and have first overlapping region in one end of the first head in the array direction. The second head is disposed upstream from and adjacent to the first head in the conveyance direction. The second head has second nozzle arrays each having second nozzles arrayed in the array direction. The second nozzle arrays are arrayed in the conveyance direction and have second overlapping region, overlapped with the first overlapping region in the array direction, in another end of the second head in the array direction. The liquid discharge method further includes causing the first head not to discharge the liquid droplets from the first nozzles of one or more of the first nozzle arrays from an upstream end of the first head in the conveyance direction in the first overlapping region as a first non-discharge nozzle array, causing the first head to discharge the liquid droplets onto the medium from the first nozzles other than the first non-discharge nozzle array in the first overlapping region, causing the second head not to discharge the liquid droplets from the second nozzles of one or more of the second nozzle arrays from a downstream end in the conveyance direction in the second overlapping region as a second non-discharge nozzle array, and causing the second head to discharge the liquid droplets onto the medium from the second nozzles other than the second non-discharge nozzle array in the second overlapping region.

### Aspect 10

A program causes a computer that controls a liquid discharge head to function as a control unit. The liquid discharge head includes multiple heads each having a nozzle array including multiple nozzles arrayed to selectively discharge liquid droplets from the nozzles onto a medium. The liquid discharge head has a nozzle overlap region of the multiple heads at ends of the multiple heads, which are disposed adjacent to each other, in an array direction of the nozzle array. The control unit controls the discharge of the liquid droplets from the nozzles. In the nozzle overlapping region, the control unit sets nozzles in a first number of rows of the nozzle array, which is one or more rows, from an upstream end of a head on a downstream side among the adjacent multiple heads in a relative movement direction of the medium with respect to the liquid discharge head as non-discharge nozzles that do not discharge the liquid droplets, and sets nozzles in a second number of rows of the nozzle array, which is one or more rows, from a downstream end of a head on an upstream side among the adjacent multiple heads in the relative movement direction as the non-discharge nozzles.

In other words, a non-transitory storage medium storing a plurality of instructions which, when executed by one or more processors, causes the one or more processors to perform a method, comprising discharging liquid droplets onto a medium and conveying at least one of multiple heads or the medium relative to another in a conveyance direction. The multiple heads include at least a first head and a second head. The first head has first nozzle arrays each having first nozzles arrayed in an array direction intersecting the conveyance direction. The first nozzle arrays are arrayed in the conveyance direction and have first overlapping region in one end of the first head in the array direction. The second head is disposed upstream from and adjacent to the first head in the conveyance direction. The second head has second nozzle arrays each having second nozzles arrayed in the array direction. The second nozzle arrays are arrayed in the conveyance direction and have second overlapping region, overlapped with the first overlapping region in the array direction, in another end of the second head in the array direction. The method further includes causing the first head not to discharge the liquid droplets from the first nozzles of one or more of the first nozzle arrays from an upstream end of the first head in the conveyance direction in the first overlapping region as a first non-discharge nozzle array, causing the first head to discharge the liquid droplets onto the medium from the first nozzles other than the first non-discharge nozzle array in the first overlapping region, causing the second head not to discharge the liquid droplets from the second nozzles of one or more of the second nozzle arrays from a downstream end in the conveyance direction in the second overlapping region as a second non-discharge nozzle array, and causing the second head to discharge the liquid droplets onto the medium from the second nozzles other than the second non-discharge nozzle array in the second overlapping region.

As described above, according to one aspect of the present disclosure, the deterioration of image quality caused by mutual interference between airflows generated between adjacent heads can be prevented.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application-Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A liquid discharge head comprising:
multiple heads to discharge liquid droplets onto a medium conveyed relative to the multiple heads in a conveyance direction, the multiple heads including at least:
a first head having first nozzle arrays each having first nozzles arrayed in an array direction intersecting the conveyance direction, the first nozzle arrays arrayed in the conveyance direction and having first overlapping region in one end of the first head in the array direction; and
a second head upstream from and adjacent to the first head in the conveyance direction, the second head having second nozzle arrays each having second nozzles arrayed in the array direction, the second nozzle arrays arrayed in the conveyance direction and having second overlapping region, overlapped with the first overlapping region in the array direction, in another end of the second head in the array direction; and
circuitry configured to:
cause the first head not to discharge the liquid droplets from the first nozzles of one or more of the first nozzle arrays from an upstream end of the first head in the conveyance direction in the first overlapping region as a first non-discharge nozzle array;
cause the first head to discharge the liquid droplets onto the medium from the first nozzles other than the first non-discharge nozzle array in the first overlapping region;
cause the second head not to discharge the liquid droplets from the second nozzles of one or more of the second nozzle arrays from a downstream end in the conveyance direction in the second overlapping region as a second non-discharge nozzle array; and
cause the second head to discharge the liquid droplets onto the medium from the second nozzles other than the second non-discharge nozzle array in the second overlapping region.

2. The liquid discharge head according to claim 1,
wherein a number of rows of the second non-discharge nozzle array is different from a number of rows of the first non-discharge nozzle array in the conveyance direction.

3. The liquid discharge head according to claim 1,
wherein a number of rows of the second non-discharge nozzle array is larger than a number of rows of the first non-discharge nozzle array in the conveyance direction.

4. The liquid discharge head according to claim 1,
wherein a number of rows of the second non-discharge nozzle array is smaller than a number of rows of the first non-discharge nozzle array in the conveyance direction.

5. The liquid discharge head according to claim 1,
wherein a number of rows of the second non-discharge nozzle array is equal to a number of rows of the first non-discharge nozzle array in the conveyance direction.

6. The liquid discharge head according to claim 1,
wherein the circuitry is further configured to:
cause the first head, in the first overlapping region:
to discharge the liquid droplets from the first nozzles in a part of a first mixed nozzle array in the first nozzle arrays; and
not to discharge the liquid droplets from the first nozzles in another part of the first mixed nozzle array in the first nozzle arrays; and
cause the second head, in the second overlapping region:
to discharge the liquid droplets from the second nozzles in a part of a second mixed nozzle array in the second nozzle arrays; and
not to discharge the liquid droplets from the second nozzles in another part of the second mixed nozzle array in the second nozzle arrays.

7. The liquid discharge head according to claim 6,
wherein the circuitry is further configured to cause:
the first head not to discharge the liquid droplets from one or more of first nozzles from an end of the first mixed nozzle array in the array direction; and
the second head not to discharge the liquid droplets from one or more of the second nozzles from an end of the second mixed nozzle array in the array direction.

8. A liquid discharge apparatus comprising:
the liquid discharge head according to claim 1;
a conveyor to convey at least one of the liquid discharge head or the medium relative to another; and
system circuitry configured to drive the liquid discharge head and the conveyor to selectively discharge the liquid droplets onto the medium to form an image on the medium.

9. A liquid discharge method comprising:
discharging liquid droplets onto a medium;
conveying at least one of multiple heads or the medium relative to another in a conveyance direction, the multiple heads including at least:
a first head having first nozzle arrays each having first nozzles arrayed in an array direction intersecting the conveyance direction, the first nozzle arrays arrayed in the conveyance direction and having first overlapping region in one end of the first head in the array direction; and
a second head upstream from and adjacent to the first head in the conveyance direction, the second head having second nozzle arrays each having second nozzles arrayed in the array direction, the second nozzle arrays arrayed in the conveyance direction and having second overlapping region, overlapped with the first overlapping region in the array direction, in another end of the second head in the array direction;
causing the first head not to discharge the liquid droplets from the first nozzles of one or more of the first nozzle arrays from an upstream end of the first head in the conveyance direction in the first overlapping region as a first non-discharge nozzle array;
causing the first head to discharge the liquid droplets onto the medium from the first nozzles other than the first non-discharge nozzle array in the first overlapping region;
causing the second head not to discharge the liquid droplets from the second nozzles of one or more of the second nozzle arrays from a downstream end in the conveyance direction in the second overlapping region as a second non-discharge nozzle array; and
causing the second head to discharge the liquid droplets onto the medium from the second nozzles other than the second non-discharge nozzle array in the second overlapping region.

10. A non-transitory storage medium storing a plurality of instructions which, when executed by one or more processors, causes the one or more processors to perform a method, comprising:
discharging liquid droplets onto a medium;
conveying at least one of multiple heads or the medium relative to another in a conveyance direction, the multiple heads including at least:
a first head having first nozzle arrays each having first nozzles arrayed in an array direction intersecting the conveyance direction, the first nozzle arrays arrayed in the conveyance direction and having first overlapping region in one end of the first head in the array direction; and
a second head upstream from and adjacent to the first head in the conveyance direction, the second head having second nozzle arrays each having second nozzles arrayed in the array direction, the second nozzle arrays arrayed in the conveyance direction and having second overlapping region, overlapped with the first overlapping region in the array direction, in another end of the second head in the array direction;
causing the first head not to discharge the liquid droplets from the first nozzles of one or more of the first nozzle arrays from an upstream end of the first head in the conveyance direction in the first overlapping region as a first non-discharge nozzle array;
causing the first head to discharge the liquid droplets onto the medium from the first nozzles other than the first non-discharge nozzle array in the first overlapping region;
causing the second head not to discharge the liquid droplets from the second nozzles of one or more of the second nozzle arrays from a downstream end in the conveyance direction in the second overlapping region as a second non-discharge nozzle array; and
causing the second head to discharge the liquid droplets onto the medium from the second nozzles other than the second non-discharge nozzle array in the second overlapping region.
